(19) United States
(12) Patent Application Publication
(10) Pub. No.: US 2026/0266084 A1
(43) Pub. Date: Sep. 10, 2026

(54) TELESCOPIC STRUCTURE

(71) Applicant: Ido Merkel, Zufim (IL)

(72) Inventor: Ido Merkel, Zufim (IL)

(21) Appl. No.: 19/167,374

(22) PCT Filed: Mar. 21, 2024
(86) PCT No.: PCT/IL2024/050292

§ 371 Date: Sep. 21, 2025

(30) Foreign Application Priority Data
Mar. 22, 2023 (IL) 301585

(51) Int. Cl. E04H 12/18

(52) U.S. Cl. CPC E04H 12/182

(57) ABSTRACT

An expandable structure comprising a central part snugly nested within at least one intermediate layer, with the intermediate layer(s) snugly nested within each other and within an outer layer. At least a portion of the central part is in contact with its adjacent layer, similarly, at least a portion of each layer is in contact with adjacent layer(s). The central part has at least one undulation on its outer side, the outer layer has at least one undulation on its inner side, and the intermediate layer(s) have, on each side, at least one undulation, with undulations on adjacent layers mating with each other. The structure is held in its expanded state by contact between the layers and by contact between the innermost layer and the central part.

### FIELD OF THE INVENTION

The present invention generally pertains to a system and method for creating an enclosed space, where the structure is expandable. In a closed configuration, all of the extensions and a central part fit into the base of the telescopic structure, with the extensions and the central part pullable or screwable from the base and lockable into an expanded position.

### BACKGROUND OF THE INVENTION

Strong, lightweight and expandable structures have many uses, from storage units to portable shelters. A very common example of an expandable structure used as a support is a tent pole. A conventional tent pole comprises several sections, where the sections are separate for transport, significantly reducing the size of the package (poles plus tent walls) that must be carried, and are assembled for use, with each section fitting into the next.

Disadvantages of sectional tent poles comprise: a group of disassembled sections is much shorter than, but significantly wider than the assembled tent pole. The locking mechanism in telescopic tent poles is weaker, sometimes significantly weaker, than the sections themselves and can be awkward both to lock and to unlock. Sideways forces on the assembled tent poles can cause them to buckle, especially at the joints. And the load that the tent poles can support is limited.

Often, more substantial portable erectable shelters are needed, where humans need protection from the environment. For example, persons may be displaced from their homes by natural disasters or be homeless due to other circumstances. Portable shelters may be used to provide either short or long term housing for such persons.

US Granted Patent No. U.S. Pat. No. 4,974,265 discloses a multi-purpose shelter adapted for use as a toilet, shower or changing enclosure of such size as to accommodate a person, having in a sectional embodiment a floor with ventilation and drainage slots surrounded by a cylindrical truncated shell containing a plurality of pliable wall sections of progressively reduced diameters which may be raised in a telescopic manner, held freestanding in an extended position by friction, is quickly and easily set up on site without tools for special instruction and collapsible into a low profile form for quick and easy transportation, storage or shipment.

However, in U.S. Pat. No. 4,974,265, the sections have flat sides and are held in an extended configuration by friction between the flat sides of the sections and by sealing tape so that the frictional force between panels is small in the extended configuration. As is stated in the patent, “a slight tap or blow will drive the sections downward over the alternating panels so that the sections become nested together in a collapsed and uniform condition inside the case”. The sealing tape is likely to lose its stickiness both with time and with repeated extension and collapse. Since only “a slight tap or blow” is needed to collapse the structure, even a moderate wind is likely to cause either collapse of the structure or leakage of material through the walls. The base of the structure is joined to the lowest vertical section only at the bottom edge of the lowest vertical section, so the base provides little stabilization for the structure and little reaction force on the sides of the structure. Since the wall sections are nested, with the innermost section being the highest when the walls are extended, the opening of each joint faces upward on the exterior of the structure. Therefore, water running down the outside of the structure (e.g., when it is raining) will flow onto the upward-facing open side of the joint and is likely to find its way through the joint and between the flat-sided sections to the interior of the structure, especially if there is wind or if sealing tape on the exterior of the structure no longer provides a continuous seal.

It is therefore a long felt need to provide an expandable structure that is not easily returned to a contracted configuration, that is not likely to develop leaks, and that is not likely to be damaged by wind or weather, or by being transported.

### SUMMARY OF THE INVENTION

It is an object of the present invention to disclose a system for creating an enclosed space, where the system is expandable. In a closed (contracted) configuration, all of the extensions (intermediate layers and central part) fit into the base (outer layer) of the telescopic structure, with the extensions pullable from the base and lockable into an expanded position.

It is another object of the present invention to disclose a structure having at least two configurations, a contracted configuration and an expanded configuration and a main longitudinal axis, said structure comprising:
a central part, having at least one central part side, and at least one of a central part upper face and a central part lower face;
at least one intermediate layer, having an intermediate layer upper face, an intermediate layer lower face, at least one intermediate layer inner side and at least one intermediate layer outer side; and
an outer layer, having at least one outer layer inward-facing side, at least one outer layer external side and at least one of an outer layer lower face or an outer layer upper face
   said central part nestable at least partially within said at least one intermediate layer and said at least one intermediate layer nestable at least partially within said outer layer;
   each of said at least one central part side, said at least one intermediate layer inner side, said at least one intermediate layer outer side and said at least one outer layer inward-facing side comprising at least two half-undulations, each of said at least two half-undulations being either an inward-angled half-undulation or an outward-angled half-undulation;
   said at least two half-undulations on said at least one central part side matable with said at least two half-undulations on said at least one intermediate layer inner side;
   said at least two half-undulations on said at least one intermediate layer outer side matable with said at least two half-undulations on said outer layer inward-facing side; and
   said at least one intermediate layer being a plurality of intermediate layers, for each pair of adjacent intermediate layers, said at least two half-undulations on an outer side of an inner of said pair of adjacent intermediate layers is matable with said at least two half-undulations on an inner side of an outer of said pair of adjacent intermediate layers; and, for each pair of adjacent intermediate layers, an inner of said each pair of adjacent intermediate layers is at least partially nestable within an outer of said each pair of adjacent intermediate layers.

It is another object of the present invention to disclose the structure as described in any of the above, wherein at least one of the following is true:
a. a member of a group consisting of said central part, said at least one intermediate layer or any combination thereof is displaceable in a direction parallel to the main longitudinal axis of the structure relative to said outer layer to transfer said expandable structure from said contracted configuration to said expanded configuration;
b. said structure is reversibly expandable;
c. a member of a group consisting of said central part, said at least one intermediate layer or any combination thereof is displaceable along the main longitudinal axis of the structure relative to said outer layer to transfer said expandable structure from said expanded configuration to said contracted configuration; and
d. all members of a group consisting of said central part, said at least one intermediate layer or any combination are fixed relative to each other.

It is another object of the present invention to disclose the structure as described in any of the above, wherein a resultant force deflected into a direction not parallel to an applied force induces each outer face into sealing communication with an inner face of an adjacent layer, thereby sealingly separating an exterior of the expandable structure from an interior of the expandable structure.

It is another object of the present invention to disclose the structure as described in any of the above, wherein a pair of adjacent layers is selected from a group consisting of said at least one intermediate layer adjacent to said central part, an adjacent pair of said plurality of intermediate layers, and said at least one intermediate layer adjacent to said outer layer.

It is another object of the present invention to disclose the structure as described in any of the above, wherein any pair of said adjacent layers is in a communication selected from slidable communication and fixed communication.

It is another object of the present invention to disclose the structure as described in any of the above, wherein, in said closed configuration at least a portion of all bottom edges of said structure are coplanar with each other, said central part fits snugly against an innermost of said at least one intermediate layer, said outer layer fits snugly against an outermost of said at least one intermediate layer, and, for said plurality of intermediate layers, said each pair of adjacent intermediate layers fit snugly against each other.

It is another object of the present invention to disclose the structure as described in any of the above 1, wherein any one of said at least two half-undulations is joined to an adjacent half-undulation in a manner selected from a group consisting of a straight segment, a curved segment or any combination thereof.

It is another object of the present invention to disclose the structure as described in any of the above, wherein each of said at least two half-undulations comprises a member of a group consisting of a spiral with an axis parallel to the main longitudinal axis of the structure, a ring lying in a plane perpendicular to parallel to the main longitudinal axis of the structure, or a crest of said at least two half-undulations being at an angle of between 30° and 90° to said main longitudinal axis of the structure.

It is another object of the present invention to disclose the structure as described in any of the above, wherein said at least two half-undulations on said central part differ from said at least two half-undulations on said at least one intermediate layer.

It is another object of the present invention to disclose the structure as described in any of the above, wherein, for said at least one intermediate layer said at least two half-undulations on an inner side of said at least one intermediate layer differ from said at least two half-undulations on an outer side of said at least one intermediate layer.

It is another object of the present invention to disclose a method of erecting a structure having at least two configurations, a contracted configuration and an expanded configuration, comprising steps of:
providing said structure, said structure having a main longitudinal axis, said structure comprising:
   a central part, having at least one central part side, and at least one of a central part upper face and a central part lower face;
   at least one intermediate layer, having an intermediate layer upper face, an intermediate layer lower face, at least one intermediate layer inner side and at least one intermediate layer outer side; and
   an outer layer, having at least one outer layer inward-facing side, at least one outer layer external side and at least one of an outer layer lower face or an outer layer upper face;
      said central part nestable at least partially within said at least one intermediate layer and said at least one intermediate layer nestable at least partially within said outer layer;
      each of said at least one central part side, said at least one intermediate layer inner side, said at least one intermediate layer outer side and said at least one outer layer inward-facing side comprising at least two half-undulations, each of said at least two half-undulations being either an inward-angled half-undulation or an outward-angled half-undulation;
      said at least two half-undulations on said at least one central part side matable with said at least two half-undulations on said at least one intermediate layer inner side;
      said at least two half-undulations on said at least one intermediate layer outer side matable with said at least two half-undulations on said outer layer inward-facing side; and
      said at least one intermediate layer being a plurality of intermediate layers, for each pair of adjacent intermediate layers, said at least two half-undulations on an outer side of an inner of said pair of adjacent intermediate layers is matable with said at least two half-undulations on an inner side of an outer of said pair of adjacent intermediate layers; and, for each pair of adjacent intermediate layers, an inner of said each pair of adjacent intermediate layers is at least partially nestable within an outer of said each pair of adjacent intermediate layers;
emplace said structure at a predetermined site; and
move said central part along said main longitudinal axis in a direction increasing a distance between said central part and said outer layer until said central part is a predetermined distance from said outer layer.

It is another object of the present invention to disclose the method as described in any of the above, additionally comprising at least one of the following steps:
a. a member of a group consisting of said central part, said at least one intermediate layer or any combination thereof is displaceable in a direction parallel to the main longitudinal axis of the structure relative to said outer layer to transfer said expandable structure from said contracted configuration to said expanded configuration;
b. said structure is reversibly expandable;
c. a member of a group consisting of said central part, said at least one intermediate layer or any combination thereof is displaceable along the main longitudinal axis of the structure relative to said outer layer to transfer said expandable structure from said expanded configuration to said contracted configuration; and
d. all members of a group consisting of said central part, said at least one intermediate layer or any combination are fixed relative to each other.

It is another object of the present invention to disclose the method as described in any of the above, additionally comprising a step of deflecting a resultant force into a direction not parallel to an applied force, inducing each outer face into sealing communication with an inner face of an adjacent layer, thereby sealingly separating an exterior of the expandable structure from an interior of the expandable structure.

It is another object of the present invention to disclose the method as described in any of the above, additionally comprising a step of selecting a pair of adjacent layers from a group consisting of said at least one intermediate layer adjacent to said central part, an adjacent pair of said plurality of intermediate layers, and said at least one intermediate layer adjacent to said outer layer.

It is another object of the present invention to disclose the method as described in any of the above, additionally comprising a step of providing any pair of said adjacent layers in a communication selected from a slidable communication and a fixed communication.

It is another object of the present invention to disclose the method as described in any of the above, additionally comprising a step of, in said closed configuration, providing at least a portion of all bottom edges of said structure coplanar with each other, said central part fitting snugly against an innermost of said at least one intermediate layer, said outer layer fitting snugly against an outermost of said at least one intermediate layer, and, for said plurality of intermediate layers, said each pair of adjacent intermediate layers fitting snugly against each other.

It is another object of the present invention to disclose the method as described in any of the above, additionally comprising a step of joining any one of said at least two half-undulations to an adjacent half-undulation in a manner selected from a group consisting of a straight segment, a curved segment or any combination thereof.

It is another object of the present invention to disclose the method as described in any of the above, additionally comprising a step of providing each of said at least two half-undulations comprising a member of a group consisting of a spiral with an axis parallel to the main longitudinal axis of the structure, a ring lying in a plane perpendicular to parallel to the main longitudinal axis of the structure, or a crest of said at least two half-undulations being at an angle of between 30° and 90° to said main longitudinal axis of the structure.

It is another object of the present invention to disclose the method as described in any of the above, additionally comprising a step of providing said at least two half-undulations on said central part differing from said at least two half-undulations on said at least one intermediate layer.

It is another object of the present invention to disclose the method as described in any of the above, additionally comprising a step of, for said at least one intermediate layer, providing said at least two half-undulations on an inner side of said at least one intermediate layer differing from said at least two half-undulations on an outer side of said at least one intermediate layer.

It is another object of the present invention to disclose a structure comprising:
a plurality of nested interlocking rings; and
an inner central part in communication with an innermost of said plurality of nested interlocking rings;
said structure comprising at least one collapsed configuration and at least one expanded configuration;
wherein said structure is transferrable between said at least one collapsed configuration and said at least one expanded configuration or between said at least one expanded configuration and said at least one collapsed configuration by application of a transfer force sufficient to overcome structural resistance between a member of a group consisting of at least one adjacent pair of said plurality of nested interlocking rings, between said inner central part and said innermost of said plurality of nested interlocking rings or any combination thereof, said transfer force being applied between said outermost of said plurality of nested interlocking rings and said inner central part;
further wherein, in said expanded configuration, a load applied to a part selected from a group consisting of said inner central part, one of said plurality of nested interlocking rings or any combination thereof induces transfer of load force and resultant force to all parts in said structure, inducing changes in angle between pairs of adjacent parts and stabilizing the structure.

It is another object of the present invention to disclose the structure as described in any of the above, wherein a snug fit exists between at least one pair of adjacent parts, said adjacent parts selected from a group consisting of said inner central part and said innermost of said plurality of nested interlocking rings, or two of said plurality of nested interlocking rings, said snug fit producing a seal between said at least one pair of adjacent parts.

It is another object of the present invention to disclose the structure as described in any of the above, wherein said transfer force is reducible for transfer between said at least one collapsed configuration and said at least one expanded configuration or for transfer between said at least one expanded configuration and said at least one collapsed configuration, said transfer force is increasable to prevent said transfer from said at least one expanded configuration to said at least one collapsed configuration, said transfer force reducible by at least partial removal of said inner central part from said innermost of said plurality of nested interlocking rings, said transfer force increasable by at least partial insertion of said inner central part into said innermost of said plurality of nested interlocking rings.

It is another object of the present invention to disclose the structure as described in any of the above, wherein a property of an outermost of said plurality of nested interlocking rings differs from said property of at least one other of said plurality of nested interlocking rings, said property selected from a group consisting of material, cross-sectional thickness, height, undulation length, undulation shape or any combination thereof.

It is another object of the present invention to disclose a method of erecting a structure having at least two configurations, a contracted configuration and an expanded configuration, comprising steps of:
providing said structure, said structure comprising:
a plurality of nested interlocking rings; and
an inner central part in communication with an innermost of said plurality of nested interlocking rings;
   said structure comprising at least one collapsed configuration and at least one expanded configuration;
emplace said structure at a predetermined site;
move said central part along a main longitudinal axis of said structure in a direction increasing a distance between said central part and said outer layer until said central part is a predetermined distance from said outer layer
wherein said structure is transferrable between said at least one collapsed configuration and said at least one expanded configuration or between said at least one expanded configuration and said at least one collapsed configuration by application of a transfer force sufficient to overcome structural resistance between a member of a group consisting of at least one adjacent pair of said plurality of nested interlocking rings, between said inner central part and said innermost of said plurality of nested interlocking rings or any combination thereof, said transfer force being applied between said outermost of said plurality of nested interlocking rings and said inner central part;
further wherein, in said expanded configuration, a load applied to a part selected from a group consisting of said inner central part, one of said plurality of nested interlocking rings or any combination thereof induces transfer of load force and resultant force to all parts in said structure, inducing changes in angle between pairs of adjacent parts and stabilizing the structure.

It is another object of the present invention to disclose the method as described in any of the above, additionally comprising a step of providing a snug fit between at least one pair of adjacent parts, said adjacent parts selected from a group consisting of said inner central part and said innermost of said plurality of nested interlocking rings, or two of said plurality of nested interlocking rings, said snug fit producing a seal between said at least one pair of adjacent parts.

It is another object of the present invention to disclose the method as described in any of the above, additionally comprising steps of reducing said transfer force for transfer between said at least one collapsed configuration and said at least one expanded configuration or for transfer between said at least one expanded configuration and said at least one collapsed configuration, or increasing said transfer force to prevent said transfer from said at least one expanded configuration to said at least one collapsed configuration, reducing said transfer force by at least partially removing said inner central part from said innermost of said plurality of nested interlocking rings, or increasing said transfer force by at least partially inserting said inner central part into said innermost of said plurality of nested interlocking rings.

It is another object of the present invention to disclose the method as described in any of the above, additionally comprising steps of selecting a property of an outermost of said plurality of nested interlocking rings differing from said property of at least one other of said plurality of nested interlocking rings, and selecting said property from a group consisting of material, cross-sectional thickness, height, undulation length, undulation shape or any combination thereof.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1A-B depicts standard structures of the prior art;

FIG. 2A-B depicts a collapsible structure of the prior art;

FIG. 3A D schematically illustrates an embodiment of an expandable structure of the present invention;

FIG. 4 schematically illustrates an embodiment of an expandable structure of the present invention in its fully-expanded configuration;

FIG. 5 schematically illustrates the angle between undulations in the sides of the parts of the present invention;

FIGS. 6A-D, 7A-C and 8A-B schematically illustrate undulations in the sides of parts of the present invention;

FIGS. 9 and 10A-D schematically illustrate embodiments of structures of the present invention;

FIGS. 11, 12 and 13A-D, schematically illustrate embodiments of structures of the present invention;

FIG. 14A schematically illustrates forces on an embodiment of an automobile comprising a structure of the present invention;

FIG. 14B schematically illustrates displacements of an automobile comprising a structure of the present invention when loaded; and

FIG. 15A-B schematically illustrates pressures on intermediate layers of an automobile comprising a structure of the present invention when loaded.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for creating an enclosed space using a telescopic expandable structure. In a closed configuration, all of the extensions (intermediate layers and central part) fit into the base (outer layer) of the telescopic structure, with the extensions pullable from the base and lockable into an expanded position.

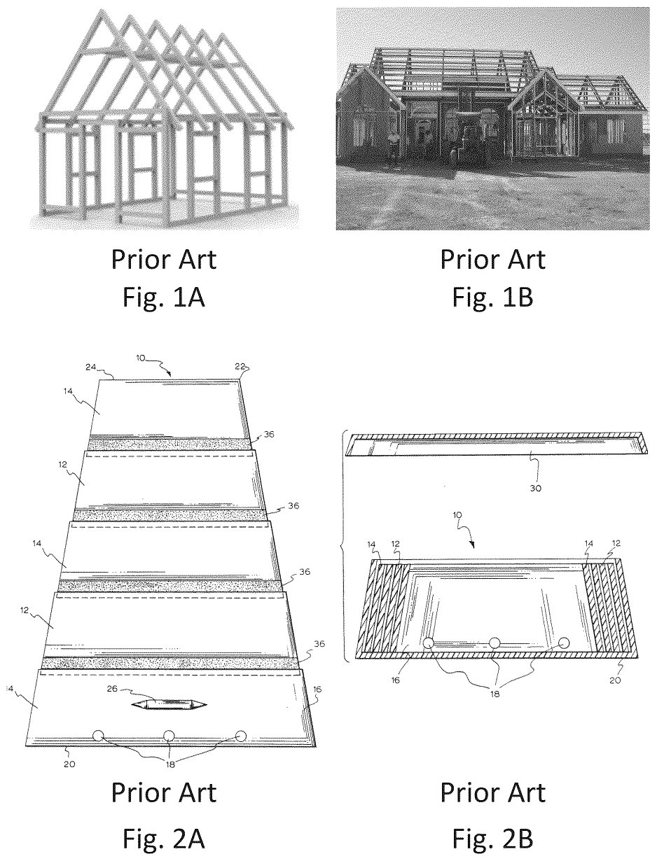

FIG. 1A-B illustrates typical embodiments of skeletons of houses. FIG. 1A illustrates a wooden skeleton for a house, while FIG. 1B illustrates a steel skeleton for a house. Buildings or other shelters can also be built with brick, stone or cement walls to support upper stories and roofs; bricks can be fired in a kiln or sun-dried. Roofs are typically wood-framed or steel-framed, with tiles or tar to keep rain out. Typically, building a one or two story house requires skilled workmen and takes about a month. After the exterior walls are finished, interior walls must be inserted, as well as electrical wiring, electric outlets, heating, lighting, facilities such as toilets and sinks, and utilities such as cupboards, as well as utilities such as stoves and refrigerators. Then the owner will add furniture.

A standard four-person tent can take 2-3 hours to set up, after which heating, lighting and cooking facilities can be unpacked and put in the tent, along with bedding, beds or other furniture (if desired). Typically, if used, a toilet and any cleaning facilities (if needed) will be in a separate structure, which must also be set up. Water can be supplied from a well or stream, from an external standpipe or a faucet in a specialized facility, or form a waterpipe. Tents can blow over in the wind and can leak, especially if something touches the walls. Wind can also make its way through the walls or through gaps in the walls.

FIG. 2A-B shows a collapsible structure intended for use as a toilet, shower or changing enclosure of such size as to accommodate a person. A larger version of such a structure could function as a collapsible tent for emergency use. However, the frictional connection between the nested sections would collapse easily—the granted patent states “a slight tap or blow” is sufficient to collapse the structure and, in extended use, the joints between the sections are likely to leak.

A trailer or caravan can be driven to a site and plugged in to facilities such as water and electricity. If available, a trailer can be connected to a waste disposal facility, or a toilet with a holding tank can be used.

In emergencies, when there has been significant destruction of housing, temporary housing is needed quickly, preferably within hours or days. Traditional-build housing takes too long. Tents can be brought in and set up quickly, with tens to hundreds of tents on a large truck; simple furniture, space heating, and cooking and storage facilities can be brought on the same truck or a separate truck and put in the tents. However, family-sized tents can take several people to set up and emplacing the furnishings takes a large number of people, as the furnishings need to be brought and emplaced in each of the tents. In addition, if the furnishings are not stored contracted, storing them requires a large amount of space. If they are stored contracted, then it requires manpower to erect them. Furthermore, ensuring that all of the needed supplies arrive at the correct site can be problematic. Also, as described above, tents are not really satisfactory for living in for extended periods of time such as months or years.

Trailers or caravans provide the amenities that tents lack, but storing the very many caravans needed—hundreds of thousands of emergency houses were needed after the recent earthquakes in Turkey—would take a very large amount of space and maintaining the caravans while in storage is expensive—unsold caravans are, in many countries, almost given away to reduce the maintenance costs of storing them. Furthermore, only a few caravans, at best, can be transported on a single truck so it would be difficult to provide transport for or transport quickly the large number of caravans needed in an emergency.

The present invention, among other uses, can provide a temporary structure that will remain wind- and water-tight for months and probably years of use. Preferably, the exterior walls comprise doors and windows. Typically, the temporary structure comprises built-in wiring and electrical connections and interior walls. Preferably, it comprises built-in furniture such as sofas and beds and other furniture such as tables and chairs; the interior walls and the furniture expanding and collapsing along with the exterior walls. Preferably, it further comprises at least one of toileting and cleansing facilities; space heating; cooking and food-cooling facilities; and storage facilities, so that, in some embodiments, a complete and furnished dwelling is suppliable as a flat pack; pulling upward on the roof extends the exterior walls, interior walls, and all internal facilities.

The present invention features:
1. Compact construction that folds telescopically
   This construction makes it possible to produce an efficient structure where almost all of the structure homogeneously resists the forces on the structure.
3. The structure is strong and is also extremely light.
4. A static labyrinth seal provides good sealing between the components, with the design ensuring a combination of pressure between the components, surface quality and number of undulation that prevents leakage between the joints.
5. In a design with a spiral undulation comprising at least one single spirally-wound intermediate layer, the construction can be opened and closed with little force (usually the weight of the product).
6. In an annular design, the force required to open or shut the structure can be planned, becomes a part of the safety factor, and, in some designs, comprises the maximum load the structure needs to support.

In designs with one or more spiral intermediate layers, with the spiral intermediate layer(s), in the open configuration, extending across a significant part of the height of the structure (preferable, but not necessarily, the full height), the stress in any part of the spiral intermediate layer(s) is small because the stress is dispersed along the entire length of each intermediate layer. In contrast, in a design comprising hoop or ring intermediate layers, if the rings have different sizes, the smaller rings have a smaller surface area and a smaller volume over which to disperse the stresses, and become a weak link in the design.

The telescopic structure of the present invention comprises three components, a center part, an outer layer and, in most embodiments, at least one intermediate layer. In some embodiments, at least one of the outer intermediate layers is fixed to the outer layer. In some embodiments, at least one inner intermediate layer is fixed to the center part. Such embodiments can have other, slidable intermediate layers, or the innermost of the fixed outer intermediate layers can slide against the outermost of the inner intermediate layers to allow expansion of the structure. It is also possible for all of the parts to be fixed to each other so that the structure cannot be expanded. All-fixed structures can be used, for non-limiting example, as a strong and lightweight flooring.

A function of the fixed intermediate layers (120) is to enable control of the size of the central part (130) or the outer layer (110), while retaining a desired size for the ends of the expanded structure. Non-limiting examples of a structures where nearly-vertical sides are desired comprise a house (nearly-vertical walls provide a more satisfactory living space) or a drinking cup, where a cup with a base close in size to its top opening stands more stable than a cup with a small base relative to its top opening. For non-limiting examples, a smaller central part (130) can provide a more stable structure than a larger central part (130).

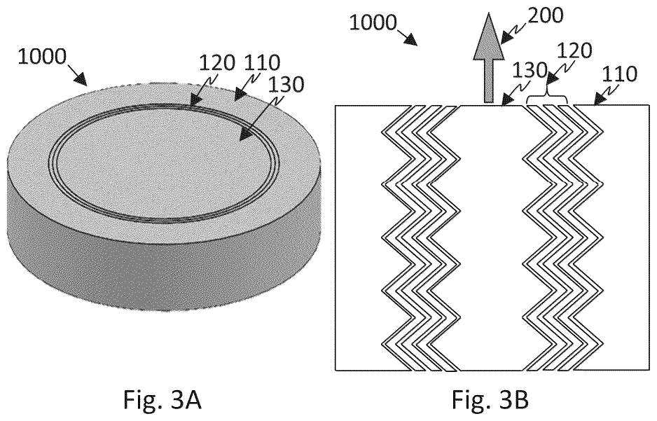

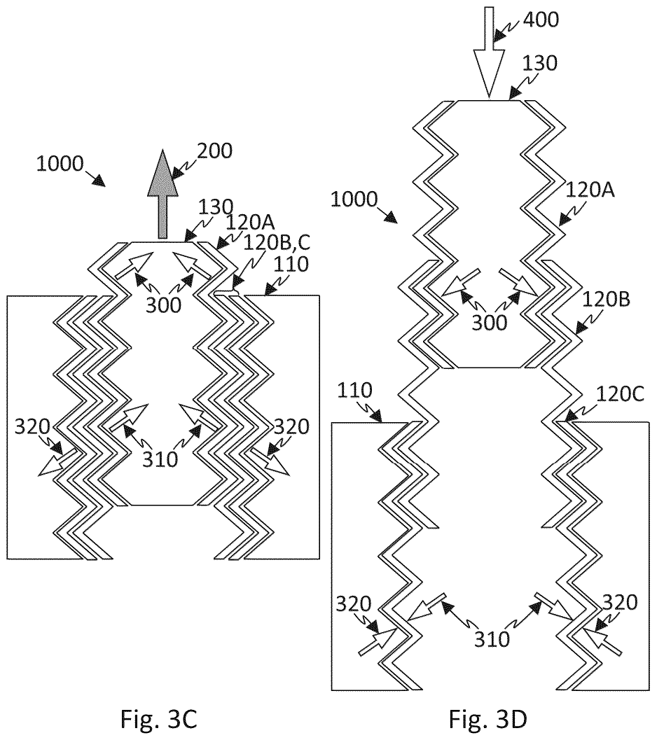

FIG. 3A-D schematically illustrates an embodiment of a telescopic structure (1000) of the present invention, with FIG. 3A showing a perspective view of the telescopic structure (1000) and FIGS. 3B-D showing a cross-section parallel to the main longitudinal axis of the embodiment of FIG. 3A. FIG. 3B shows the telescopic structure (1000) in its closed configuration, FIG. 3C shows the telescopic structure (1000) in a partly-open configuration, and FIG. 3D shows the telescopic structure (1000) in a fully-open configuration.

In FIGS. 3A-D and 4, small undulations may or may not be present. For simplicity and clarity, they are not shown.

The outer layer (110), the three intermediate layers (120) and the central part (130) are shown separated for clarity. In practice, they would fit snugly against each other, snugly enough that the outer layer, the intermediate layers and the central part are in sealing communication at all times.

In all configurations of all structures, the parts of the telescopic structure (1000) nest at least partially within each other, the central part (130) within the intermediate layer(s) (120), the intermediate layer(s) (120) within each other and the outermost intermediate layer (120) within the base (110).

Typically, as shown in FIG. 3A, in the closed configuration, the top edges of the outer layer (110), the intermediate layers (120) and the central part (130) are coplanar, as are the bottom edges (not shown). This makes the telescopic structure (1000), in its closed configuration, effectively a “flat pack”, providing for very space-efficient storage and transport of the telescopic structure (1000). Typically, the central part will have a connector (not shown) to allow it to be connected to a means of pulling upward on the central part (130) to expand the telescopic structure (1000). Any suitable conventional connector can be used; the type of connector is not germane to the patent.

In the embodiment as shown in FIGS. 3B-3D, the outer intermediate layer (120C) is fixed to the outer layer and the inner intermediate layer (120A) is fixed to the center part (130), with the central intermediate layer (120B) slidable against the outer intermediate layer (120C) and the inner intermediate layer (120A).

The central part has undulations on its outer side, while the outer layer has undulations on its inner side. The intermediate layers have undulations on both sides, all of the undulations matching so that there is a snug, sealable fit between the parts.

In FIG. 3B, force (200, grey arrow) is being applied in an upward direction. This causes the central intermediate layer (120B), which is flexible, to jump upward, as shown in FIG. 3C, where the innermost intermediate layer (120A) has jumped upward by one undulation. The uppermost white arrows (300) schematically illustrate the direction of the force on the innermost intermediate layer (120A) and, therefore, on the central intermediate layer (120B), the force is not parallel to the main longitudinal axis but is angled due to the undulations. Note that the upward pulling process draws the intermediate layers (120A) closer to the central part (130), helping to maintain the sealing between the parts of the telescopic structure (1000)

The lower white arrows (310) schematically illustrate the direction of the force on the innermost intermediate layer (120A) and, therefore, on the central and outer intermediate layers (120B,C); the force is not parallel to the main longitudinal axis but is angled due to the undulations. However, there is a reaction force (320) on the inner, central and outer intermediate layers (120A,B,C) from the outer layer (110), putting the intermediate layers (120) in equilibrium when static and close to equilibrium when being opened or closed, or otherwise undergoing a dynamic force, as discussed in more detail below.

FIG. 3D schematically illustrates the telescopic structure (1000) in a fully-expanded configuration. Note that, in other variants of this embodiment, in the fully-expanded configuration, one undulation in the middle intermediate layer (120A) is in contact with the central part (130), and one undulation in the middle intermediate layer (120A) is in contact with the outer layer (110).

In FIG. 3D, the pulling force has ceased; the load (400) on the telescopic structure (1000) is the weight of the central part (130) plus the weight of any additional matter resting on the telescopic structure (1000).

Since the force is now downward, the load (400) pushes the intermediate layers outward and downward (300, arrows), increasing the pressure on the intermediate layers (120A,B), helping to maintain the sealing between the parts of the telescopic structure (1000).

The lower white arrows (310) schematically illustrate the direction of the force on the innermost intermediate layer (120A) and, therefore, on the central and outer intermediate layers (120B,C) due to the load; the force is not parallel to the main longitudinal axis but is angled outward due to the undulations. However, there is a reaction force (320) on the inner, central and outer intermediate layers (120A,B,C) from the outer layer (110), putting the intermediate layers (120) in equilibrium, as discussed in more detail below.

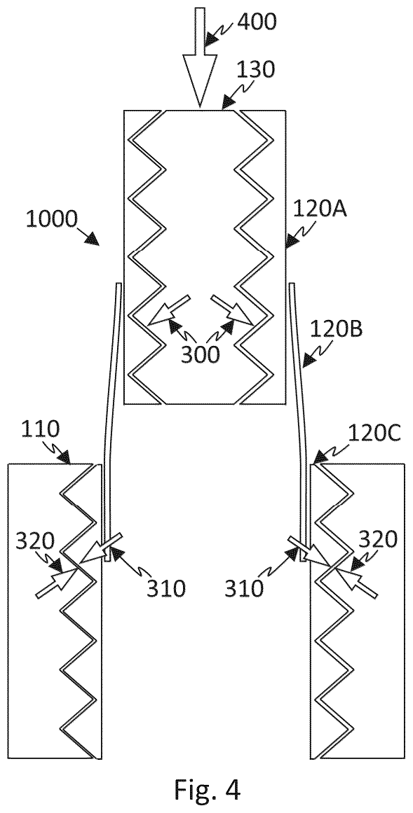

FIG. 4 shows another embodiment of a telescopic structure (1000) with three intermediate layers (120A,B,C), the innermost (120A) and the outermost (120C) fixed and the central intermediate layer (120B) slidable. In this embodiment, the central intermediate layer (120B), when unstressed, is flat; as shown in FIG. 4, it has bowed under pressure from the load (400) on the central part (130), the bowing forcing the central intermediate layer (120B) into sealing contact with the outer layer (110) and the central part (130).

It should be noted that, in practice, there can be anywhere from no intermediate layers to a very large number of intermediate layers (120); for example, more than a thousand. The number of intermediate layers (120) can depend, for non-limiting example, on the load they need to carry, the fully expanded length of the telescopic structure (1000), the materials used, and the maximum length that will preserve the sealing contact between the intermediate layers (120), the central part (130) and the outer layer (110).

The load (400) pushes the intermediate layers outward and downward (300, arrows), increasing the pressure on the intermediate layers (120A,B), helping to maintain the sealing between the parts of the telescopic structure (1000).

The lower white arrows (310) schematically illustrate the direction of the force on the innermost intermediate layer (120A) and, therefore, on the central and outer intermediate layers (120B,C) due to the load; the force is not parallel to the main longitudinal axis but is angled outward due to the undulations. However, there is a reaction force (320) on the intermediate layers (120A,B,C) from the outer layer (110), putting the intermediate layers (120) in equilibrium, as discussed in more detail below.

As discussed above, the forces on the intermediate layers (120) are at an angle to the main longitudinal axis due to the undulations, thereby putting stress on the central part (130), the intermediate layers (120) and the outer layer (110). The force on the outer layer (110) stretches it outward, generating an inward-directed stress. This inward-directed stress puts a reaction force on the intermediate layers (120), so that the intermediate layers (120) are close to equilibrium. Preferably, stresses on the midsurfaces of the intermediate layers (120) will be close to zero. If the expanding or contracting of the telescopic structure (1000) is not too rapid, the intermediate layers (120) will remain in close to equilibrium during expansion or contraction, resulting in increased strength and stability of the telescopic structure (1000) during expansion or contraction. The intermediate layers (120) will be in equilibrium when the telescopic structure (1000) has been fully expanded and is in use.

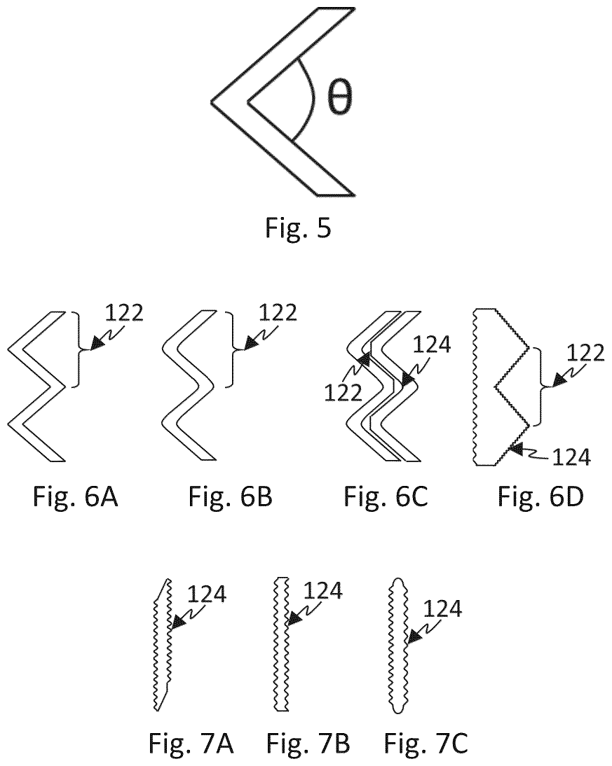

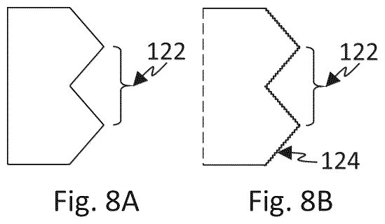

FIGS. 5, 6A-D, 7A-C and 8A-B schematically illustrate exemplary shapes for the parts (110, 120, 130). Undulations on the sides of the parts can be large or small. FIGS. 6D and 8B schematically illustrate parts with both large and small undulations, FIGS. 6A-C and 8A show parts with large undulations (122) only and FIGS. 7A-C schematically illustrate parts with small undulations (124) only.

FIG. 5 schematically indicates the angle θ between undulations. The angle can be in a range 0<θ<180°. The angle θ_{L} between large undulations can be different from the angle θ_{S} between small undulations. Either or both of θ_{L} and θ_{S} can be different between the different sides of any intermediate layer, although θ_{L} and θ_{S} should be the same for any pair of contacting faces, so that contacting faces match each other, thereby ensuring that there exists an appropriate coefficient of friction between contacting faces. It should be noted that the coefficient of friction between faces depends on the material of each contacting part and the roughness of each contacting face; the number, length and angle θ_{L} of large undulations, and the number, length and angle θ_{S} of small undulations and all of these must be “tuned” to provide acceptable behavior for the expandable device.

In some embodiments, at least a portion of at least one of the parts has a surface finish. The surface finish can be of a food-grade material, it can be an anti-corrosion finish, or any other conventional finish. In some embodiments, a combination of the surface finish, the size of the undualtions, the shape of the undulations and any combination thereof can minimize or prevent bacterial growth on the parts.

All parts have at least one set of undulations on at least part of at least one side, and a part can have both large and small undulations. Typically, if there is only one set of undulations, they will be small undulations, In FIGS. 6A-C, only the large undulations (122) are shown, while in FIG. 6D, one side has both large and small undulations. FIG. 6A schematically illustrates an intermediate layer (120) with the undulations meeting at points. FIG. 6B schematically illustrates an undulating intermediate layer (120) with the undulations meeting at a radiused end.

FIG. 6C schematically illustrates two mating intermediate layers (120), where each of the mating intermediate layers (120) alternates a radiused end (126) and a flat end (128), so that there is a small gap between each radiused end (126) and each flat end (128), thereby, for non-limiting example, making a screw-shaped undulation easier to turn, or making transfer of one intermediate layer (120) to a different undulation (122, 124) of an adjacent intermediate layer (120) smoother.

FIG. 6D schematically illustrates an intermediate layer (120) with one side having large and small undulations, and the other side having only small undulations. Typically, the side with large undulations would be fixed to another part, typically a central part (130) or an outer layer (110). A fixed connection between two adjoining layers can be formed by having the properties of the adjoining mating faces, such as the large and small undulations, the materials, and the surface roughnesses such that the force to cause relative movement between them is much larger than the force needed to cause relative movement between slidable faces, or they are permanently linked together at at least one point, where the linking can be by means of melting them together, adhering them, or any other means of permanently linking two parts. Typically, the side with the small undulations only would be slidable against another layer, typically another intermediate layer (120).

FIGS. 7A-C schematically illustrate shapes for the terminal ends of an intermediate layer. FIG. 7A schematically illustrates terminal ends for an intermediate layer (120) that would be substantially parallel to a top or bottom plane of the central part (130) or outer layer (110). FIG. 7B schematically illustrates terminal ends that are perpendicular to the main longitudinal axis of the intermediate layer (120), and FIG. 7C schematically illustrates an intermediate layer (120) with radiused ends.

Radiused ends and radiused undulations can be circular, elliptical, hyperbolic, or polygonal. A polygonal radiusing can have between 1 and 100 segments; a polygonal radius with one segment would be a flat end.

FIG. 8A schematically illustrates large undulations (122) on an outer layer (110), while FIG. 8B schematically illustrates large undulations (122) and small undulations (124) on a central part (130), where the dashed line indicates the centerline of the central part (130).

Stresses on the parts of the telescopic structure (1000) can, in theory, be calculated using either Johnson's parabolic formula or the Euler critical buckling load formula, according to the slenderness ratio of the part. Typically, however, it is more practical to calculate the stresses using stress analysis.

Johnson's parabolic formula relates the critical buckling stress σ_{cr} to the applied stress σ_{y}, in the thickness direction of the beam, in this case, the stress in an intermediate layer (120) in a direction perpendicular to the main longitudinal axis of the structure, the modulus of elasticity E and the slenderness ratio l/k, where 1 is the length of the intermediate layer (120) in a direction parallel to the main longitudinal axis of the structure and k is the radius of gyration of the intermediate layer (120). The critical buckling stress σ_{cr} is

$${σ}_{cr} = {σ}_{y} - \frac{1}{E} {( \frac{{σ}_{y}}{2 π} )}^{2} ( \frac{l}{k} ) \qquad ( 1 )$$

The Euler critical buckling load formula relates the critical buckling stress σ_{cr} to a critical force P_{cr}, where the critical buckling stress is

$${σ}_{cr} = \frac{{P}_{cr}}{A} = \frac{{π}^{2} EI}{{AL}_{e}^{2}} = \frac{{π}^{2} E}{{( \frac{l}{k} )}^{2}} \qquad ( 2 )$$

where
P_{cr}=critical force
A=area of cross section
Lₑ=effective length of the rod, which is, for the parts of the present invention, typically the thickness of the part
E=modulus of elasticity (Young's modulus)
I=area moment of inertia of the cross section of the rod
=slenderness ratio k
l=moment of inertia of a column section
k=radius of gyration of a column section

The change in diameter of a column section δl can be calculated from:

$$δ l = pdl \frac{( 0.5 - μ )}{2 tE} \qquad ( 4 )$$

And the hoop stress σₕ can be calculated from

$${σ}_{h} = \frac{pd}{2 t} \qquad ( 5 )$$

where
E=Modulus of elasticity (Young's modulus)
μ=Poisson's ratio
p=internal pressure
d=cylindrical shell diameter
t=shell thickness
L=length of shell

An advantage of the telescopic structure (1000) of the present invention is that it provides a compact and lightweight system. The materials used for the parts of the telescopic structure (1000), the center part (130), the intermediate layers (120) and the outer layer (110) can be anything from a hyperelastic material to a rigid material, depending on the use to which the telescopic structure (1000) is to be put. Non-limiting examples of possible materials comprise a metal, a polymer, a composite, an aggregate, a shape memory material, wood, diamond, shell, or any combination thereof. The material is selected based on, for non-limiting example, the size of the intended structure, the environmental conditions it will be exposed to during storage, transportation and use, and the forces it will need to safely withstand during storage, transportation and use. The center part (130), the intermediate layers (120) and the outer layer (110) can be of the same material or of different materials.

Undulations (122, 124) in the sides of the parts, which can be used to control friction between adjacent sides, have a minimum wavelength of about 3 nm. More typically, undulations (122, 124) have a wavelength in a range selected from 0.5 mm to 1 mm, 0.1 mm to 10 mm, 3 nm to 1 μm, or any combination thereof. Large undulations (122) can also have a wavelength in a range from 0.5 mm to 1 mm, 0.1 mm to 10 mm, 10 mm to 100 mm, 10 mm to 1 m, larger than 1 m, or any combination thereof. The size of the large undulations will depend on the size of the part they are part of, namely the thickness of the center part (130) or outer layer (110), or the width of an intermediate layer (120).

Undulations typically comprise two half-undulations, an inward-pointing half-undulation and an outward-pointing half-undulation. Inward-pointing half-undulations and outward-pointing half-undulations can be mirror images of each other or can be different. The shape of an inward-pointing half-undulation can be the same as the shape of an adjacent outward-pointing half-undulation or they can be different. A half-undulation can comprise a linear portion, a curved portion or any combination thereof. Non-limiting examples of an undulation profile comprise a sinusoidal profile, a zigzag profile, a sawtooth profile, a curvilinear profile or any combination thereof.

Nano-sized undulations would be used, for non-limiting example, for micrometer-sized devices such as sensors of MEMS devices. Millimeter-sized small undulations would be used for larger devices such as, for non-limiting example, cars, furniture, houses, white goods, or units for space stations or for living installations in hostile environments.

The cross-sectional shape of a telescopic structure (1000) can be curved, such as, but not limited to, circular or elliptical; polygonal, with the polygon having up to 106 sides; defined by a spline curve; or any combination thereof. If the telescopic structure (1000) is used for emergency housing, it would typically be rectangular as this is the shape that is most easily transportable using current transport means.

The center part (130) can have a design that allows a change in its diameter, reducing the resistance to expansion or contraction of the telescopic structure (1000).

The center part (130) can have a design with sides in a direction parallel to the main longitudinal axis of the structure or the sides can slope inward, with the center part (130) having the shape of a frustum of a cone, wider at the bottom (internal side of the central part) and narrower at the top (external side of the central part). The central part can be pulled outward in a direction parallel to the main longitudinal axis of the structure, or can be rotated so that it and the intermediate layers are screwed outward from the outer layer. In the case where the central part is rotated, the undulation forms a spiral rather than the ring undulations used when the central part is pulled upward.

Preferably, the central part (130) has a relatively small diameter to increase the stability of the structure by reducing the amount of deflection of the central part and/or the tendency of the central part to buckle, thereby enabling a larger or stronger telescopic structure (1000). For non-limiting example, for a thin circular plate clamped at the edges under a transverse load, the plate deflection depends approximately on the square of the plate radius.

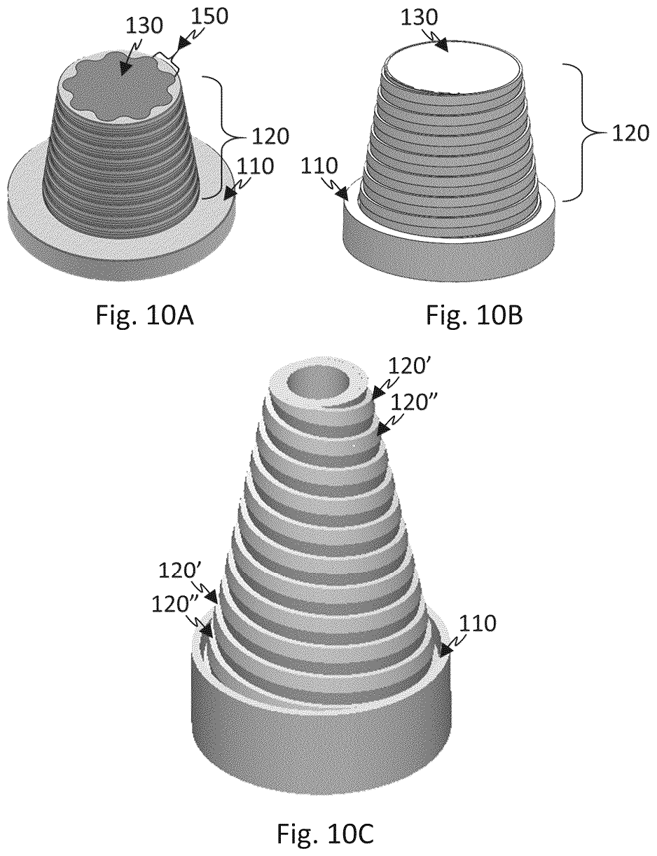

By having a central part (130) that has a cross-section perpendicular to the main longitudinal axis of variable size, such as, but not limited to, the lobed central part of FIG. 10A (below) or by having a central part shaped like the frustum of a cone and screwing it inward before pulling is to expand the structure, or by removal of the central part, the force needed to expand the telescopic structure (1000) can be significantly reduced or almost eliminated, thereby separating the load the structure needs to withstand during use from the force needed to expand (or contract) it.

Since a telescopic structure (1000) of a desired height can be designed with intermediate layers (120) of different lengths, a telescopic structure (1000) with shorter intermediate layers having more of them and a telescopic structure (1000) with longer intermediate layers (120) having fewer, a closed (contracted) telescopic structure (1000) can be made thicker or thinner almost as desired, while the size of the footprint of the telescopic structure (1000), which depends on the cross-sectional area of the central part (120), the cross-sectional area of the outer layer (110), and the thickness and number of intermediate layers (120), will change little as the length of the intermediate layers (120) changes. Therefore, the closed and transportable telescopic structure (1000) can comprise a compact package,

The usable volume of the telescopic structure (1000) is approximately the volume within the walls and is therefore approximately the area of the hollow interior of the outer layer (110), as the walls, although angled inward, make a relatively small angle in a direction parallel to the main longitudinal axis of the structure.

The thicknesses and lengths needed for the intermediate layers (120) could, in principle, be calculated from eqs. 4 and 5. If ring undulations are used, their thickness and length could be found from σₕ; if the undulations form a spiral, their thickness and length could be found from 1σₕ, where 1 is the length of the spiral. Typically, however, instead of using eqs. 4 and 5, stress analysis will be carried out on embodiments of the proposed structure and the materials of the parts and their dimensions are adjusted until a proposed structure will provide the desired function safely and efficiently.

The outer layer (110) inner and outer diameters and the outer layer (110) thickness can be determined from the intended function of the structure, the materials used for the outer layer (110), and from the applied stresses on the outer layer (110). Typically, determination of the diameters and thickness is done by means of stress analysis applied to the entire intended structure.

The design of the present invention, with three nested parts (center part, intermediate layer(s) and outer layer) with different functions, enable construction of a lightweight structure which can carry very heavy loads. For example, a structure consisting of ABS (acrylonitrile butadiene styrene) plastic can carry about 700 kg per square centimeter for a 1 mm thick layer. As disclosed above, this ability is the result of the distribution of the forces so that the center lines of the intermediate layers are essentially stress-free. Having a small diameter central part and a plurality of intermediate layers fixed to the central part means that the central part and its associated fixed intermediate layers can have a small height (thickness) and still have the required strength and stability, while reducing the weight of the structure.

The number of fixed intermediate layers can also be altered in order to provide a structure with a desired steepness of the side walls. Two structures can be compared, both having an outer layer with the same inner diameter and no associated fixed intermediate layers, and both having a central part with the same outer diameter, with the central part of the first structure having few (or no) associated fixed intermediate layers and the central part of the second having many associated fixed intermediate layers, the first structure will look from the outside like the frustum of a cone, while the second structure will look almost cylindrical from the outside.

The outer ring applies an inward annular pressure to the intermediate layers from the hoop stresses applied to it by the outermost intermediate layer. The intermediate layer(s) get their strength from the stability of the structure.

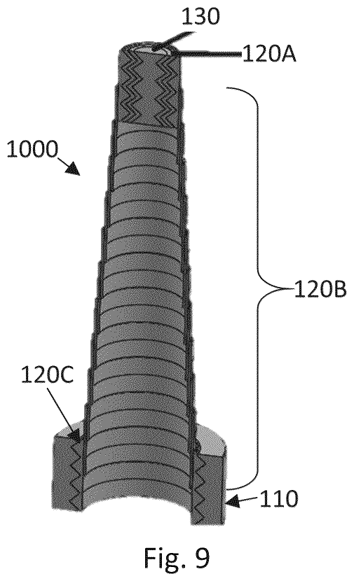

FIG. 9 illustrates an embodiment of a structure in its expanded configuration. The expandable structure (1000) comprises a base member (110) supporting the structure on a surface (not shown). The intermediate layers (120A, B, C) comprise a plurality of successively connected layers, as described above. At the top is the central part (130) and, in this embodiment, three intermediate layers (120A) fixed to the central part (130). Each of the fixed intermediate layers (120A) has internal and external undulations on their side surfaces. The internal side surface of an outer fixed intermediate layer (120A) is profiled in a conformal manner with the external side surface of an adjacent fixed intermediate layer (120A). The profile of the side surfaces of the fixed intermediate layers (120A) comprises both large undulations and small undulations. It should be emphasized that profiled side surfaces have an enlarged contact area such that the hoop stress induced by the load of interest supporting by the structure (1000) is decreased because it is spread over the enlarged contact area.

Similarly, there is a fixed intermediate layer (120C) with both large and small undulations linked to the base (110).

The slidable intermediate layers (120B) have only the small undulations, being substantially rectangular in cross section.

FIGS. 10A-D show embodiments of the present invention with a spirally-expandable intermediate layer (120). The intermediate layer (120) is substantially tape-shaped member and is configurable into contracted and expanded positions. In the contracted position (not shown), at least one tape-shaped intermediate layer (120) is spirally nested in the outer layer (110). The sides of the tape-shaped intermediate layer(s) (120) have small undulations and are profiled such that successive winds of the tape-shaped intermediate layer (120) remain engaged with each other when the tape-shaped intermediate layer (120) is in its expanded configuration.

In order to expand the structure, either the center part (130) it is pulled up or the center part is rotated; in the exemplary embodiment of FIG. 10B, if the center part (110) is fixed to the tape-shaped intermediate layer(s) (120) and the tape-shaped intermediate layer(s) (120) are fixed to the outer layer (110), the center part (110) is rotated counterclockwise to expand the structure and clockwise to contract the structure. In the exemplary embodiment of FIG. 10C-D, if the center part (110) is fixed to the tape-shaped intermediate layer(s) (120) and the tape-shaped intermediate layer(s) (120) are fixed to the outer layer (110), the center part (110) is rotated clockwise to expand the structure and counterclockwise to contract the structure. In FIG. 10C, for clarity, the central part is not shown and in FIG. 10D, for clarity, neither the central part nor the outer layer is shown.

FIG. 10A shows an embodiment where the cross-sections of the center part (130) perpendicular to the main longitudinal axis are lobed (150); in the embodiment shown, the cross-sections perpendicular to the main longitudinal axis have nine lobes (150). Each lobe (150) runs parallel to the longitudinal axis of the embodiment. The lobes (150) can function as large undulations, thereby reducing the tendency of the device to close if a large load is placed on it. The lobes (150) can also function to reduce the force needed to expand the device. If the crests of the lobes (150) in the center part are adjacent to crests of the lobes (150) in the innermost intermediate layer, then the force exerted by the center part (130) on the intermediate layer(s) (120) is relatively small and relative motion between the intermediate layer(s) (120) and the central part (130) is relatively easy, so that expansion of the structure by pulling on the central part (130) takes relatively little force. However, if the crests of the lobes (150) in the center part are adjacent to troughs of the lobes (150) in the innermost intermediate layer, then the force exerted by the center part (130) on the intermediate layer(s) (120) is large and relative motion between the intermediate layer(s) (120) and the central part (130) is very difficult, locking the structure in the current configuration.

FIG. 10B-D shows an embodiment where the cross-sections of the center part (130) perpendicular to the main longitudinal axis are substantially circular. In the embodiment of FIG. 10B, there is one tape-shaped intermediate layer (120), whereas in FIGS. 10C-D, there are two tape-shaped intermediate layers (120′, 120″) In spiral embodiments, having more than one tape-shaped intermediate layer makes the system more reliable, since the ends of the tape-shaped intermediate layer(s) are typically attached to the central part or to an intermediate layer fixed to the central part. If there is only one tape-shaped intermediate layer, during a change of configuration, either from contracted to expanded or expanded to contracted, the central part (130) will tend to rock as is moves upward or downward, since it is held to the tape-shaped intermediate layer only at one point. Such rocking can cause disconnection between the winds of the tape-shaped intermediate layer, preventing the change in configuration of the structure. If there are two tape-shaped intermediate layers, fixed to the central part or to the fixed intermediate layers at opposite sides of the central part, then the forces at the connection points will be similar, significantly reducing rocking and increasing the reliability of the structure. More than two tape-shaped intermediate layers can be used; the number of tape-shaped intermediate layers is limited only by the circumference of the central part or fixed intermediate layer to which they are attached and by the widths of the tape-shaped intermediate layers.

The design of the system makes it possible to generate designs for and produce structures that are liquid-proof and gasproof.

In the sealing method of the present invention, the components are designed such that the forces exerted on the central part, the intermediate layer(s) and the outer layer by their weight, the weight above them and the pressures exerted on them press them together with relatively large forces, thereby forcing the undulations on their sides into intimate contact and generating a liquid- and gas-proof seal between adjacent parts. The quality of the seal can be calculated at the design stage through the well-known formulas for a ‘static labyrinth seal’.

A few non-limiting examples of systems where liquid- and gas-proof sealing is necessary for at least some parts of the system:
1. A house. Houses require walls and a roof that are impermeable to at least wind and water. House doors and windows, when closed, should be at least substantially wind- and water-proof. Inside the house, items such as, but not limited to, sinks, toilets, baths and showers should not leak, nor should items such as, but not limited to, water pipes or gas pipes. Leakage of air from ovens, refrigerators and other heating and cooling means can cause unpleasant and possibly dangerous temperature variations
2. A portable toilet. The toilet itself must not leak, nor, if provided, should any washing facilities. In addition, liquid storage tanks, for storage of wastes or for fresh water (if a flush toilet or for washing facilities is provided) must not leak.
3. A collapsible cup.
4. A space station. In addition to preventing leakage of items within the space station, such as toilets, heating and cooling means, and piping, leakage of atmosphere through the walls of the space station must be prevented.

### Example 1

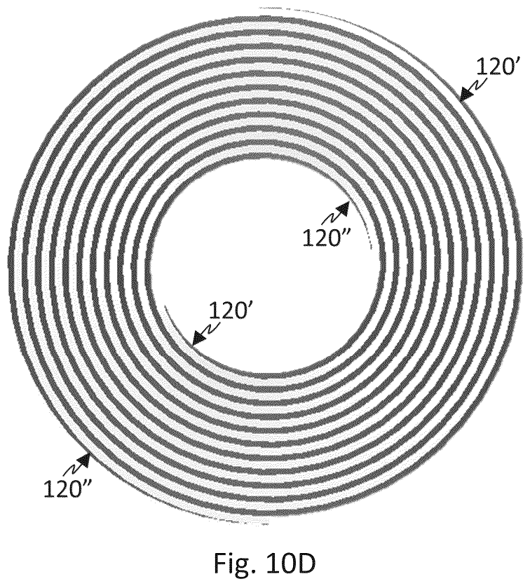

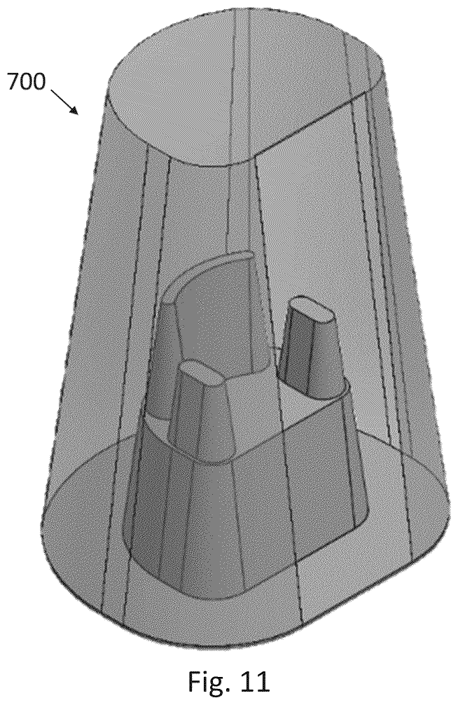

FIG. 11 shows a portable toilet cubicle in its expanded configuration. About 600 of these could be stored in a standard 12 m container with a volume of about 66 m³. In practice, depending on the weight of the portable toilet cubicle and any relevant weight limits on the transporting vehicle, a smaller container can be used or fewer toilet cubicles can be stored in each container.

### Example 2

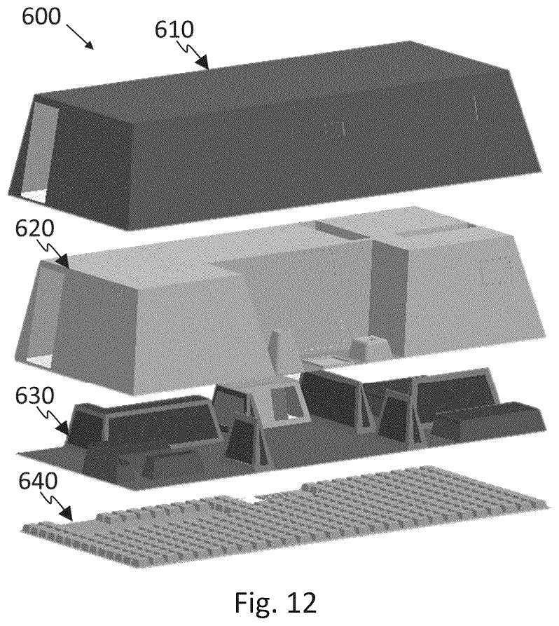

FIG. 12 shows a furnished house (600) that contains all the infrastructure and services to enable a normal life. About 75 houses of 50 square meters can be transported on one truck. The houses are intended for emergencies and are spread over plowed fields. Erection takes only two people and requires only a few minutes, typically less than ten minutes. Typically, in use, services such as electricity and water are supplied. Any conventional electricity generator can be provided and wiring run to each house and plugged into an external socket. Water can be supplied in any conventional manner, such as from a water truck or from a well or stream, with water pipes run to each house and plugged in to an external connector. Waste disposal can either be via an internal holding tank that must be emptied periodically or, if available, to a septic tank or mains drainage. In FIG. 12, the external walls (610), internal walls (620) and furniture (630) are all constructed of the present invention, as are the windows (not shown) and doors (not shown). The base (640) both provides the needed reaction forces and provides the house's floor. The electrical wiring and pipes for water and waste can be built into the walls. In use, a conventional electricity generator can be provided to the site, with wiring run to each house and plugged into an external outlet for each house. Water can be provided by a conventional means and the water supply connected to each house. Waste can either be stored in an internal storage facility, such as is conventionally used with camping trailers and portable toilets, or the house can be connected to a conventional drain or septic tank.

In some embodiments, at least one of the following can be built into the house or supplied with it: bedding, clothing, food, cleaning supplies, cooking supplies, dishes, pots and pans, cutlery, a refrigerator, cooking facilities, a TV, or cleaning facilities such as a washing machine or drier.

### Example 3

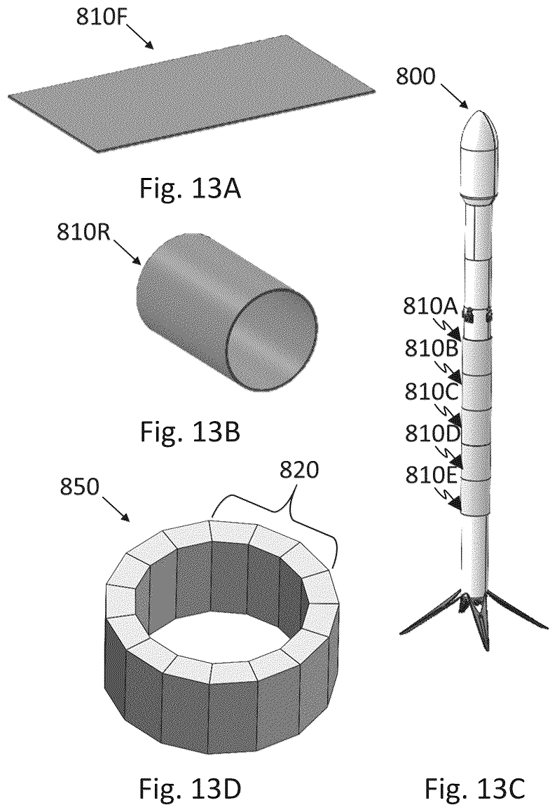

FIG. 13A-C schematically illustrates how a space station can be assembled and sent into space. FIG. 13A schematically illustrates a single unit (820F) of the space station in a contracted configuration. The unit (820) can be a dwelling, a ground-based embodiment of which is shown expanded in FIG. 12, above, a laboratory, a meeting room, a dining room, an entrance-exit area, a storage area, or any other enclosed area as needed in a space station. Preferably, facilities are included, in contracted form, inside the unit (820). For non-limiting example, the laboratory unit could comprise heating and cooling facilities, workbenches, seating, lighting, attachment points for equipment, fume hoods, storage space for supplies, or other items or facilities needed to equip the laboratory of interest.

FIG. 13B schematically illustrates the contracted unit (820R) as rolled into a cylindrical form in preparation for transport into space, with the ends of the unit (820R) reversibly sealed to each other or otherwise linked together. Any conventional reversible sealing or linking means can be used, as long as the sealing or linking means does not damage the unit and can withstand the forces applied to the unit (820) during launching of a rocket into space.

FIG. 13C schematically illustrates 15 units mounted on the outside of a rocket (800), in this illustrative example, a SpaceX Falcon 9 rocket, although any rocket of an appropriate size and power could be used. As shown in FIG. 13C, each row of units (820A-E) comprises a stack three deep on the outside of the rocket.

FIG. 13D schematically illustrates a 15-unit (820) space station (850) after assembly in space. The units (850) are about 50 m² and are connected in a ring that can be rotated to generate gravity. Inhabitants of a space station (850) comprising a ring of 100 units (820) could experience a substantially Earth-like environment. If the floors of the units (820) are at the outer circumference of the space station (850) and the space station (850) rotates at approximately 19 rpm, the centrifugal force that the inhabitants experience would be approximately the same as Earth's gravitational force, providing the inhabitants with a comfortable living environment; a larger space station (850) would require a slower rotation and a smaller space station (850) would require a faster rotation,

### Example 4

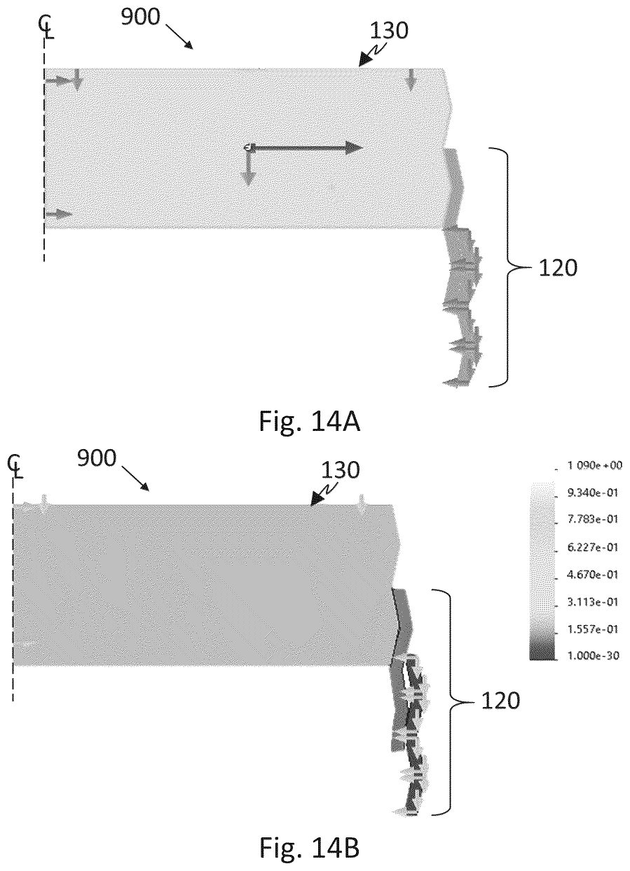

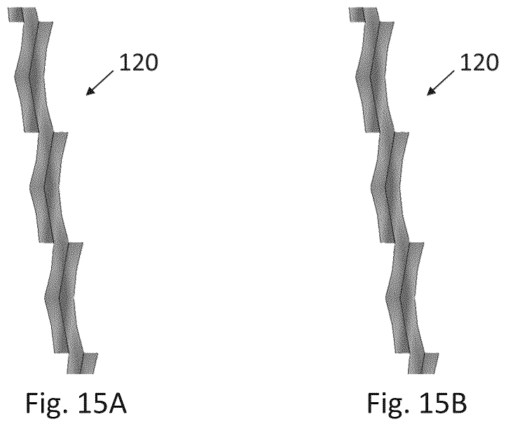

FIGS. 14A-B and 15-A-B show an exemplary embodiment of an automobile where the structural material for the vehicle comprises primarily ABS. FIGS. 14A-B show a cross-section of the central part (130), which is the top of the car, and a few of the intermediate layers (120), while FIGS. 15A-B show a few of the intermediate layers (120). The outer layer is not shown. FIGS. 14A-B show displacements of the central part (130) and a few of the intermediate layers (120), while FIGS. 15A-B show the stresses on the intermediate layers (120).

The exemplary vehicle is 1.5 m high, 2 m wide and 4 m long, about the size of a compact car, and weighs less than 200 kg. In the exemplary vehicle, the central part comprises the roof of the vehicle. In this design, the roof (central part) is fixed only to the uppermost of the intermediate layers; each of the intermediate layers is slidable against any adjacent intermediate layer. The 150 intermediate layers (only a few are shown) and the outer layer form the walls of the vehicle.

Computer simulations of the stresses in such a vehicle indicate that it could withstand a load of 40 tons.

In most countries, standard tests are applied to new vehicle designs, to ensure minimum safety standards for the new design. The standards specify the directions and magnitudes of the applied forces and the locations on the vehicle where the forces are applied.

FIG. 14A-B and FIG. 15A-B show results of a simulation where the loads are similar to the loads in a standard test that is done on a normal compact car. In this test, the allowed deformation of the chassis of the vehicle is typically about 20 mm.

In the standard test, a 4G force is applied, in other words, the applied force is 4*G*W, where G is the acceleration due to gravity and W is the eight of the car. For a typical car, a typical 4G force applied to the vehicle is 17,000 N. This was the force applied to the exemplary vehicle, although it weighs less than 200 kg, instead of the more than 1 ton of a typical vehicle of its size.

FIG. 14A shows the loads (arrows at the center of the central part (130)) applied in the simulation to the central part (130) and the restraints (small grey arrows) applied to the center line and top of the central part (130) and to the outside of the lower intermediate layer (120). The applied loads in the simulation are

$${F}_{x} = 4.89 \times {10}^{5} N ( horizontal arrow )$$

$${F}_{y} = - 6.76 \times {10}^{3} N ( vertical arrow )$$

FIG. 14B shows the displacements of the parts due to the applied forces; the maximum displacement is 1.09 mm, well below the typical value of 20 mm. The intermediate layers get thinner; more importantly, the direction of the distortion is outward (mid grey, upper intermediate layer) for each of the intermediate layers. Because the distortions are outward and because the forces and pressures are distributed evenly throughout the vehicle, a material like ABS can withstand loads of about 700 kg per square centimeter for a 1 mm thick layer.

FIGS. 15A-B show the pressures in the intermediate layers, with FIG. 15A showing the pressures but not the deformations of the intermediate layers, while FIG. 15B shows both the pressures and the deformations. The pressures are small, being very close to zero in the centers of the intermediate layers and the pressure distributions in the different intermediate layers are almost identical.

As shown in FIGS. 14A-B and 15A-B, loads applied to any part of the structure induce transfer of load force and resultant force to all parts of the structure, inducing changes in angle between pairs of adjacent parts and stabilizing the structure.

1. A structure having at least two configurations, a contracted configuration and an expanded configuration and a main longitudinal axis, said structure comprising:
a central part, having at least one central part side, and at least one of a central part upper face and a central part lower face;
at least one intermediate layer, having an intermediate layer upper face, an intermediate layer lower face, at least one intermediate layer inner side and at least one intermediate layer outer side; and
an outer layer, having at least one outer layer inward-facing side, at least one outer layer external side and at least one of an outer layer lower face, and an outer layer upper face, said outer layer having a throughgoing bore, an axis of said bore being parallel to said main longitudinal axis;
said central part nestable at least partially within said at least one intermediate layer and said at least one intermediate layer nestable at least partially within said throughgoing bore of said outer layer;
each of said at least one central part side, said at least one intermediate layer inner side, said at least one intermediate layer outer side and said at least one outer layer inward-facing side comprising at least two half-undulations, each of said at least two half-undulations being either an inward-angled half-undulation or an outward-angled half-undulation;
said at least two half-undulations on said at least one central part side matable with said at least two half-undulations on said at least one intermediate layer inner side;
said at least two half-undulations on said at least one intermediate layer outer side matable with said at least two half-undulations on said outer layer inward-facing side;
said at least one intermediate layer being a plurality of intermediate layers, for each pair of adjacent intermediate layers, said at least two half-undulations on an outer side of an inner of said pair of adjacent intermediate layers is matable with said at least two half-undulations on an inner side of an outer of said pair of adjacent intermediate layers; and, for each pair of adjacent intermediate layers, an inner of said each pair of adjacent intermediate layers is at least partially nestable within an outer of said each pair of adjacent intermediate layers;
wherein said structure, in said expanded configuration, is maintained in said expanded configuration by said nesting of said central part at least partly within said at least one intermediate layer and said nesting of said at least one intermediate layer within said throughgoing bore of said outer layer and by contact between adjacent lavers, said adjacent lavers being said central part and said at least one intermediate layer; said at least one intermediate layer being a plurality of intermediate layers, said pair of adjacent intermediate layers; and said at least one intermediate layer and said outer layer; without need for supporting structure on an external side linking any first outward facing side to any second outward facing side or supporting structure on an internal side linking any first inward facing side to any second inward facing side.

2. The structure of claim 1, wherein at least one of the following is true:
a. a member of the group consisting of said central part, said at least one intermediate layer or any combination thereof is displaceable in a direction parallel to the main longitudinal axis of the structure relative to said outer layer to transfer said expandable structure from said contracted configuration to said expanded configuration;
b. said structure is reversibly expandable;
c. a member of the group consisting of said central part, said at least one intermediate layer or any combination thereof is displaceable along the main longitudinal axis of the structure relative to said outer layer to transfer said expandable structure from said expanded configuration to said contracted configuration;
d. all members of the group consisting of said central part, said at least one intermediate layer or any combination are fixed relative to each other;
e. a resultant force deflected into a direction not parallel to an applied force induces each outer face into sealing communication with an inner face of an adjacent laver, thereby sealingly separating an exterior of the expandable structure from an interior of the expandable structure;
f. in said closed configuration at least a portion of all bottom edges of said structure are coplanar with each other, said central part fits snugly against an innermost of said at least one intermediate layer, said outer layer fits snugly against an outermost of said at least one intermediate layer, and, for said plurality of intermediate layers, said each pair of adjacent intermediate layers fit snugly against each other;
g. any one of said at least two half-undulations is joined to an adjacent half-undulation in a manner selected from a group consisting of a straight segment, a curved segment or any combination thereof;
h. each of said at least two half-undulations comprises a member of a group consisting of a spiral with an axis parallel to the main longitudinal axis of the structure, a ring lying in a plane perpendicular to parallel to the main longitudinal axis of the structure, or a crest of said at least two half-undulations being at an angle of between 30° and 90° to said main longitudinal axis of the structure;
i. a property of said at least two half-undulations on said central part differs from said property of said at least two half-undulations on said at least one intermediate layer, said property selected from the group consisting of material of each contacting part, roughness of each contacting face, angle θ_{L} between large undulations, number of large undulations, length of large undulations, number of small undulations, length of small undulations, angle θ_{S} of small undulations, large undulation profile or any combination thereof; or
j. for said at least one intermediate layer, a property of said at least two half-undulations on an inner side of said at least one intermediate layer differs from said property of said at least two half-undulations on an outer side of said at least one intermediate layer, said property selected from the group consisting of material of each contacting part, roughness of each contacting face, angle θ_{L} between large undulations, number of large undulations, length of large undulations, number of small undulations, length of small undulations, angle θ_{S} of small undulations, large undulation profile or any combination thereof.

3. (canceled)

4. The structure of claim 1, wherein a pair of adjacent layers is selected from the group consisting of said at least one intermediate layer adjacent to said central part, an adjacent pair of said plurality of intermediate layers, and said at least one intermediate layer adjacent to said outer layer.

5. The structure of claim 4, wherein any pair of said adjacent layers is in a communication selected from slidable communication and fixed communication.

6. (canceled)

7. (canceled)

8. (canceled)

9. (canceled)

10. (canceled)

11. A method of erecting a structure having at least two configurations, a contracted configuration and an expanded configuration, comprising steps of:
providing said structure, said structure having a main longitudinal axis, said structure comprising:
a central part, having at least one central part side, and at least one of a central part upper face and a central part lower face;
at least one intermediate layer, having an intermediate layer upper face, an intermediate layer lower face, at least one intermediate layer inner side and at least one intermediate layer outer side; and
an outer layer, having at least one outer layer inward-facing side, at least one outer layer external side and at least one of an outer layer lower face and an outer layer upper face, said outer layer having a throughgoing bore, an axis of said bore being parallel to said main longitudinal axis;
said central part nestable at least partially within said at least one intermediate layer and said at least one intermediate layer nestable at least partially within said throughgoing bore of said outer layer;
each of said at least one central part side, said at least one intermediate layer inner side, said at least one intermediate layer outer side and said at least one outer layer inward-facing side comprising at least two half-undulations, each of said at least two half-undulations being either an inward-angled half-undulation or an outward-angled half-undulation;
said at least two half-undulations on said at least one central part side matable with said at least two half-undulations on said at least one intermediate layer inner side;
said at least two half-undulations on said at least one intermediate layer outer side matable with said at least two half-undulations on said outer layer inward-facing side;
said at least one intermediate layer being a plurality of intermediate layers, for each pair of adjacent intermediate layers, said at least two half-undulations on an outer side of an inner of said pair of adjacent intermediate layers is matable with said at least two half-undulations on an inner side of an outer of said pair of adjacent intermediate layers; and, for each pair of adjacent intermediate lavers an inner of said each pair of adjacent intermediate layers is at least partially nestable within an outer of said each pair of adjacent intermediate layers;
emplacing said structure at a predetermined site; and
moving said central part along said main longitudinal axis in a direction increasing a distance between said central part and said outer layer until said central part is a predetermined distance from said outer layer,
wherein said structure, in said expanded configuration, is maintained in said expanded configuration by said nesting of said central part at least partly within said at least one intermediate layer and said nesting of said at least one intermediate layer within said throughgoing bore of said outer layer and by contact between adjacent layers, said adjacent layers being said central part and said at least one intermediate layer; said at least one intermediate layer being a plurality of intermediate layers, said pair of adjacent intermediate lavers; and said at least one intermediate layer and said outer layer; without need for supporting structure on an external side linking any first outward facing side to any second outward facing side or supporting structure on an internal side linking any first inward facing side to any second inward facing side.

12. The method of claim 11, additionally comprising at least one of the following steps:
a. a member of the group consisting of said central part, said at least one intermediate layer or any combination thereof is displaceable in a direction parallel to the main longitudinal axis of the structure relative to said outer layer to transfer said expandable structure from said contracted configuration to said expanded configuration;
b. said structure is reversibly expandable;
c. a member of the group consisting of said central part, said at least one intermediate layer or any combination thereof is displaceable along the main longitudinal axis of the structure relative to said outer layer to transfer said expandable structure from said expanded configuration to said contracted configuration; or
d. all members of a group consisting of said central part, said at least one intermediate layer or any combination are fixed relative to each other.

13. The method of claim 11, additionally comprising a step of deflecting a resultant force into a direction not parallel to an applied force inducing each outer face into sealing communication with an inner face of an adjacent layer, thereby sealingly separating an exterior of the expandable structure from an interior of the expandable structure.

14. The method of claim 11, additionally comprising a step of selecting a pair of adjacent layers from the group consisting of said at least one intermediate layer adjacent to said central part, an adjacent pair of said plurality of intermediate layers, and said at least one intermediate layer adjacent to said outer layer.

15. The method of claim 14, additionally comprising a step of providing any pair of said adjacent layers in a communication selected from a slidable communication and a fixed communication.

16. The method of claim 11, additionally comprising a step of, in said closed configuration, providing at least a portion of all bottom edges of said structure coplanar with each other, said central part fitting snugly against an innermost of said at least one intermediate layer, said outer layer fitting snugly against an outermost of said at least one intermediate layer, and, for said plurality of intermediate layers, said each pair of adjacent intermediate layers fitting snugly against each other.

17. The method of claim 11, additionally comprising a step of joining any one of said at least two half-undulations to an adjacent half-undulation in a manner selected from the group consisting of a straight segment, a curved segment or any combination thereof.

18. The method of claim 11, additionally comprising at least one of the following steps:
a. providing each of said at least two half-undulations comprising a member of the group consisting of a spiral with an axis parallel to the main longitudinal axis of the structure, a ring lying in a plane perpendicular to parallel to the main longitudinal axis of the structure, or a crest of said at least two half-undulations being at an angle of between 30° and 90° to said main longitudinal axis of the structure;
b. selecting a property of said at least two half-undulations on said central part differing from said property of said at least two half-undulations on said at least one intermediate layer, and selecting said property from the group consisting of material of each contacting part, roughness of each contacting face, angle θ_{L} between large undulations, number of large undulations, length of large undulations, number of small undulations, length of small undulations, angle θ_{S} of small undulations, large undulation profile or any combination thereof, or
c. for said at least one intermediate layer, selecting a property of said at least two half-undulations on an inner side of said at least one intermediate layer differing from said property of said at least two half-undulations on an outer side of said at least one intermediate laver, and selecting said property from the group consisting of material of each contacting part, roughness of each contacting face, angle θ_{L} between large undulations, number of large undulations, length of large undulations, number of small undulations, length of small undulations, angle θ_{S} of small undulations, large undulation profile or any combination thereof.

19. (canceled)

20. (canceled)

21. A structure comprising:
a plurality of nested interlocking rings; and
an inner central part in communication with an innermost of said plurality of nested interlocking rings;
said structure comprising at least one collapsed configuration and at least one expanded configuration;
wherein said structure is transferrable between said at least one collapsed configuration and said at least one expanded configuration or between said at least one expanded configuration and said at least one collapsed configuration by application of a transfer force sufficient to overcome structural resistance between a member of the group consisting of at least one adjacent pair of said plurality of nested interlocking rings, between said inner central part and said innermost of said plurality of nested interlocking rings or any combination thereof, said transfer force being applied between said outermost of said plurality of nested interlocking rings and said inner central part,
further wherein said structure, in said expanded configuration, is maintained in said expanded configuration by said nesting of said central part at least partly within said at least one intermediate layer and said nesting of said at least one intermediate layer within said throughgoing bore of said outer layer and by contact between adjacent layers, said adjacent lavers being said central part and said at least one intermediate layer; said at least one intermediate layer being a plurality of intermediate layers, said pair of adjacent intermediate layers; and said at least one intermediate layer and said outer layer; without need for supporting structure on an external side linking any first outward facing side to any second outward facing side or supporting structure on an internal side linking any first inward facing side to any second inward facing side.

22. The structure of claim 21, wherein a snug fit exists between at least one pair of adjacent parts, said adjacent parts selected from the group consisting of said inner central part and said innermost of said plurality of nested interlocking rings, or two of said plurality of nested interlocking rings, said snug fit producing a seal between said at least one pair of adjacent parts.

23. The structure of claim 21, wherein said transfer force is reducible for transfer between said at least one collapsed configuration and said at least one expanded configuration or for transfer between said at least one expanded configuration and said at least one collapsed configuration, said transfer force is increasable to prevent said transfer from said at least one expanded configuration to said at least one collapsed configuration, said transfer force reducible by at least partial removal of said inner central part from said innermost of said plurality of nested interlocking rings, said transfer force increasable by at least partial insertion of said inner central part into said innermost of said plurality of nested interlocking rings.

24. The structure of claim 21, wherein a property of an outermost of said plurality of nested interlocking rings differs from said property of at least one other of said plurality of nested interlocking rings, said property selected from the group consisting of material, cross-sectional thickness, height, undulation length, undulation shape, large undulation profile, or any combination thereof.

25. A method of erecting a structure having at least two configurations, a contracted configuration and an expanded configuration, comprising steps of:
providing said structure, said structure comprising:
a plurality of nested interlocking rings; and
an inner central part in communication with an innermost of said plurality of nested interlocking rings;
said structure comprising at least one collapsed configuration and at least one expanded configuration;
emplacing said structure at a predetermined site;
moving said central part along a main longitudinal axis of said structure in a direction increasing a distance between said central part and said outer layer until said central part is a predetermined distance from said outer layer,
wherein said structure is transferrable between said at least one collapsed configuration and said at least one expanded configuration or between said at least one expanded configuration and said at least one collapsed configuration by application of a transfer force sufficient to overcome structural resistance between a member of a group consisting of at least one adjacent pair of said plurality of nested interlocking rings, between said inner central part and said innermost of said plurality of nested interlocking rings or any combination thereof, said transfer force being applied between said outermost of said plurality of nested interlocking rings and said inner central part,
further wherein said structure, in said expanded configuration, is maintained in said expanded configuration by said nesting of said central part at least partly within said at least one intermediate layer and said nesting of said at least one intermediate layer within said throughgoing bore of said outer layer and by contact between adjacent layers, said adjacent layers being said central part and said at least one intermediate layer; said at least one intermediate layer being a plurality of intermediate layers, said pair of adjacent intermediate layers; and said at least one intermediate layer and said outer layer; without need for supporting structure on an external side linking any first outward facing side to any second outward facing side or supporting structure on an internal side linking any first inward facing side to any second inward facing side.

26. The method of claim 25, additionally comprising a step of providing a snug fit between at least one pair of adjacent parts, said adjacent parts selected from the group consisting of said inner central part and said innermost of said plurality of nested interlocking rings, or two of said plurality of nested interlocking rings, said snug fit producing a seal between said at least one pair of adjacent parts.

27. The method of claim 25, additionally comprising steps of reducing said transfer force for transfer between said at least one collapsed configuration and said at least one expanded configuration or for transfer between said at least one expanded configuration and said at least one collapsed configuration, or increasing said transfer force to prevent said transfer from said at least one expanded configuration to said at least one collapsed configuration, reducing said transfer force by at least partially removing said inner central part from said innermost of said plurality of nested interlocking rings, or increasing said transfer force by at least partially inserting said inner central part into said innermost of said plurality of nested interlocking rings.

28. The method of claim 25, additionally comprising steps of selecting a property of an outermost of said plurality of nested interlocking rings differing from said property of at least one other of said plurality of nested interlocking rings, and selecting said property from the group consisting of material, cross-sectional thickness, height, undulation length, large undulation profile, undulation shape or any combination thereof.
